(19) United States
(12) Patent Application Publication
(10) Pub. No.: US 2003/0037668 A1
(43) Pub. Date: Feb. 27, 2003

(54) Hydraulic cylinder stroke stop mounting

(76) Inventor: Alan Nastasi, Hayesville, OH (US)

Correspondence Address: WEI TE CHUNG, FOXCONN INTERNATIONAL, INC., 1650 MEMOREX DRIVE, SANTA CLARA, CA, 95050, US

(21) Appl. No.: 09/934,197

(22) Filed: Aug. 21, 2001

(51) Int. Cl. F15B 15/22

(52) U.S. Cl. 91/401

(57) ABSTRACT

An under body hydraulic cylinder is disclosed having a poppet relief valve disposed through a piston. As the piston is moved by oil pressure towards the stuffing box, the poppet relief valve engages a stroke stop mounted on a stuffing box surrounding the piston rod. As the poppet engages the stroke stop, the poppet is opened to allow oil to bypass the piston. The cylinder stroke is determined by the length of the stroke stop mounted on the stuffing box.

### FIELD OF THE INVENTION

This invention relates to the field of hydraulic cylinders and, in particular, to stroke stops and poppet relief valves in hydraulic cylinders.

### BACKGROUND OF THE INVENTION

The general operation of hydraulic cylinders is well known in the art. A poppet relief valve is commonly found in hydraulic cylinders to prevent the build up of hydraulic pressure. Stroke is often limited by an additional stop inserted over the cylinder rod. A common hydraulic cylinder design is shown in FIG. 1. Stroke stop 90 is used to define the stroke by way of its length. Spacer 32 is held away from poppet 26 by wave spring 30. At the full extension of piston 20 and rod 38, wave spring 30 is compressed, allowing poppet 26 to come into contact with spacer 32, which is held in location on stroke stop 90 by weld 34. Poppet 26 is forced back into poppet sleeve 28, opening seal 24 and allowing oil to bypass through piston 20 to prevent pressure build up.

While the above design is common in the art, it does not yield itself to efficient production. Because of the location in piston 20, poppet 26 must be actuated by spacer 32, which is attached to stroke stop 90 by weld 34. As a result, this is a somewhat complex design.

Several alternatives to the above design exist in the prior art. For example, U.S. Pat. No. 4,337,687, issued to Hoover, discloses a poppet trip device adapted to hydraulic cylinders having a poppet axially movable within a poppet sleeve extended through a piston. The poppet head extends outwardly from the piston to engage the cylinder head in response to movement from the piston. Such engagement unseats the poppet to allow fluid communication through the poppet sleeve. The stroke stop is accomplished with the cylinder stuffing box only.

U.S. Pat. No. 5,540,136, issued to Noord, relates to a reciprocating piston motor. First and second valve members are received in the piston. Contact with a stop at the end of the cylinder causes the first valve member to close and the second to open. Contact with another stop at the opposite end of the cylinder causes the opposite effect. Stops are located at each end of the cylinder due to the reciprocating aspect of this piston.

These arrangements still do not provide for an efficient means to produce a stroke stop that will also actuate the poppet in its common location in the piston. Therefore, what is needed is a poppet and stroke stop design that lends itself to efficient production.

### SUMMARY OF THE INVENTION

The present invention is an underbody hydraulic cylinder having a stroke stop mounted on the stuffing box at the cylinder end. A standardized piston casting is disposed within the cylinder. The piston includes a poppet relief valve disposed through the piston casting. Oil pressure moves the piston away from the cylinder head, in turn moving a piston rod attached to the piston casting. As the piston moves away from the cylinder head, the poppet relief valve engages a stroke stop mounted on a stuffing box surrounding the piston rod. The position of the stroke stop defines the length of the cylinder stroke. As the poppet relief valve engages the stroke stop, the poppet is opened and oil may bypass the piston into the oil reservoir of the cylinder. Oil exits the cylinder through an oil return port.

The positioning of the stroke stop on the stuffing box not only exactly defines the length of the cylinder stroke and provides actuation of the poppet, but also allows for efficient production of the cylinder as a whole.

Therefore, it is an aspect of the invention to provide a hydraulic cylinder with a stroke stop mounted on the stuffing box.

It is a further aspect of the invention to provide a stroke stop for a hydraulic cylinder that is easily removed.

It is yet another aspect of the invention to provide a stroke stop that is easily changed to a different stroke by way of its length.

These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

FIG. 1 is a cut away view of a common prior art embodiment of a hydraulic cylinder with a spacer.

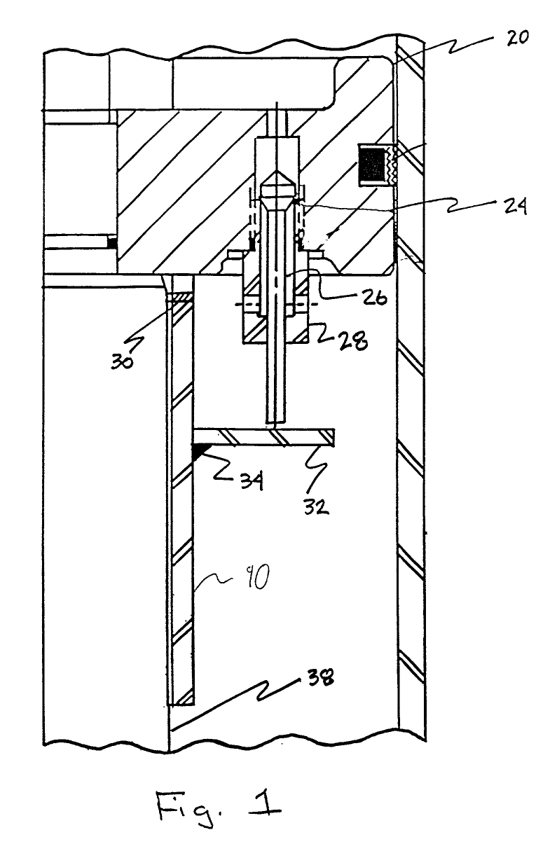

FIG. 2 is a cut away view of a preferred embodiment of the present invention.

### DETAILED DESCRIPTION OF THE INVENTION

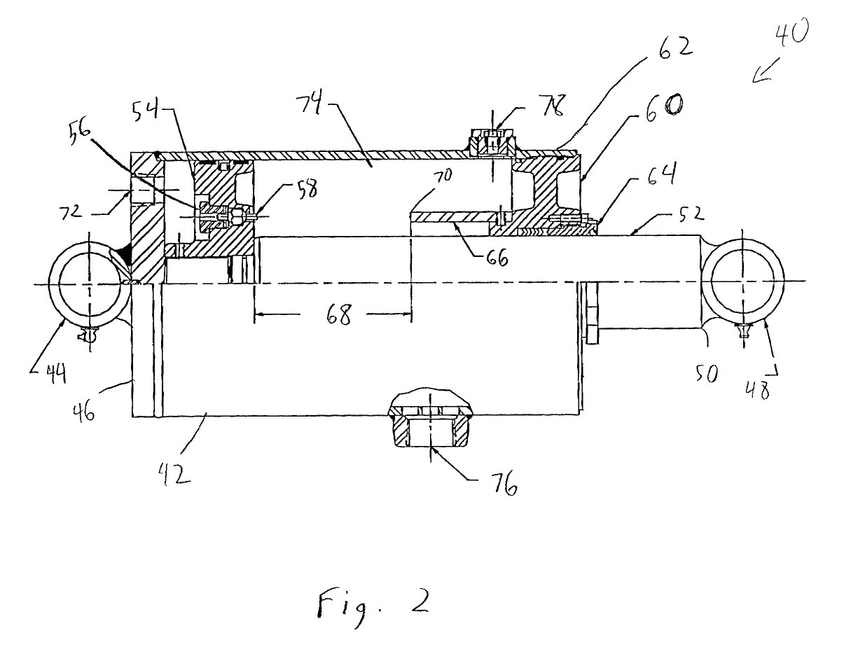

The present invention is shown in FIG. 2. Hydraulic cylinder 40 is preferably used as an under body cylinder. Cylinder body 42 includes mounting 44 attached to cylinder base 46. Mounting 44 is used to mount hydraulic cylinder 40 to the underbody of a vehicle or apparatus. Second mounting 48 is attached to distal end 50 of piston rod 52. Second mounting 48 works in conjunction with mounting 44 to mount the hydraulic cylinder.

Piston 54, which is preferably a standard piston casting, is movably disposed within cylinder 42. Poppet relief valve 58 is disposed through piston 54. Poppet 58 is retained by adapter 56. Poppet 58 seals piston 54 to prevent oil (not shown) from bypassing piston 54 as hydraulic pressure begins to build.

Piston rod 52 is attached to piston 54. Distal end 50 extends through a hole in stuffing box 60. Piston rod 52 moves with piston 54, being slidably disposed through stuffing box 60. Piston rod 52 is preferably a solid rod.

Stuffing box 60 is disposed about piston rod 52 at cylinder end 62. Seals 64 are included between stuffing box 60 and the rod. Preferably, seals 64 are adjustable to allow for the best possible fit. Seals 64 assist in preventing any oil from leaking around piston rod 52.

Stroke stop 66 is mounted on stuffing box 60 inside cylinder 42. Stroke stop 66 defines cylinder stroke 68 by the stroke stop's position from stuffing box 60. Preferably, cylinder stroke 68 is typically 20″, but can vary according to the length of stroke stop 66. End 70 of stroke stop 66 engages poppet 58 as piston 54 moves towards stuffing box 60. When poppet 58 is engaged, the relief valve is opened, preventing the potentially dangerous build up of excess hydraulic pressure. As stroke stop 66 is mounted directly on stuffing box 60, it is removable along with the stuffing box.

Oil enters the cylinder through extend port 72. The hydraulic pressure built up by the oil moves piston 54 towards stuffing box 60. As piston 54 moves, stroke stop 66 engages poppet 58 with end 70, opening the relief valve and allowing the oil to bypass piston 54. Oil moves through poppet relief valve 58 to oil reservoir 74, reducing the hydraulic pressure on piston 54 and causing cylinder stroke 68 to end at stroke stop 66. Oil entering oil reservoir 74 exits the cylinder through oil return port 76.

Hydraulic cylinder 40 also preferably includes filter vent 78. This vent is mounted outside cylinder 42 and offers access to oil reservoir 74.

Although the present invention has been described with reference to certain preferred embodiments thereof, other versions are readily apparent to those of ordinary skill in the art. Therefore, the spirit and scope of the appended claims should not be limited to the description of the preferred embodiments contained herein.

What is claimed is:

1. A hydraulic cylinder comprising:
a cylinder having a cylinder end and a cylinder stroke;
a piston disposed within said cylinder;
a poppet relief valve disposed through said piston;
a stuffing box removably disposed at said cylinder end;
a piston rod extending from said piston through said stuffing box; and
a stroke stop having a length mounted on said stuffing box inside said cylinder;
wherein said piston is moved towards said stuffing box by hydraulic pressure, and wherein said poppet relief valve engages said stroke stop as said piston moves towards said stuffing box preventing excess build up of said hydraulic pressure, and wherein said length of said stroke stop directly determines said cylinder stroke.

2. The hydraulic cylinder as claimed in claim 1, wherein said piston rod further comprises a distal end having a first mount, and wherein said cylinder further comprises a cylinder head having a second mount, wherein said hydraulic cylinder is mounted on an apparatus using said first and second mounts.

3. The hydraulic cylinder as claimed in claim 1 further comprising an extend port in said cylinder, wherein oil enters said cylinder through said extend port to build up hydraulic pressure.

4. The hydraulic cylinder as claimed in claim 3 further comprising an oil return port, wherein said oil exits said cylinder after traveling through said poppet relief valve when said poppet relief valve engages said stroke stop.

5. The hydraulic cylinder as claimed in claim 1, wherein said stuffing box further comprises adjustable seals disposed about said piston rod.

6. The hydraulic cylinder as claimed in claim 1 further comprising a filter vent disposed on said cylinder.

7. A hydraulic cylinder comprising:
a cylinder having a cylinder head, a cylinder end, and a cylinder stroke;
a piston disposed within said cylinder;
a poppet relief valve disposed through said piston;
a stuffing box having seals, said stuffing box being removably disposed at said cylinder end;
a piston rod extending from said piston having a distal end slidably disposed through said stuffing box, said seals of said stuffing box being disposed about said piston rod;
a stroke stop having a length mounted on said stuffing box inside said cylinder;
an extend port disposed in said cylinder head;
an oil return port disposed on said cylinder;
a first mounting mounted on said distal end of said piston rod; and
a second mounting mounted on said cylinder head;
wherein said piston is moved towards said stuffing box by hydraulic pressure from oil entering said cylinder through said extend port, and wherein said poppet relief valve engages said stroke stop as said piston moves towards said stuffing box preventing excess build up of said hydraulic pressure by allowing said oil to pass through said poppet relief valve and out said oil return port, and wherein said length of said stroke stop directly determines said cylinder stroke, and wherein said hydraulic cylinder is mounted on an apparatus my means of said first and second mountings.

8. The hydraulic cylinder as claimed in claim 7 further comprising a filter vent disposed on said cylinder in proximity with said stuffing box.

9. The hydraulic cylinder as claimed in claim 7, wherein said seals are adjustable.
